(19) United States
(12) Patent Application Publication
(10) Pub. No.: US 2010/0267337 A1
(43) Pub. Date: Oct. 21, 2010

(54) PRINTING SYSTEM AND METHOD FOR PORTABLE WIRELESS DEVICE

(75) Inventors: YI-FANG WU, Tu-Cheng (TW); YONG-HUI XIAO, Shenzhen City (CN); YUN-CHUN DAI, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY (ShenZhen) CO. LTD., Shenzhen City (CN); HON HAI PRECISION INDUSTRY CO., LTD., Tu-Cheng (TW)

(21) Appl. No.: 12/551,727

(22) Filed: Sep. 1, 2009

(30) Foreign Application Priority Data
Apr. 20, 2009 (CN) 200910301677.8

(51) Int. Cl. H04B 7/00; H04M 1/00; G06F 3/12

(52) U.S. Cl. 455/41.3; 455/557; 358/1.15

(57) ABSTRACT

A printing system includes a printer and a portable wireless device coupled to the printer. The printer includes a wireless communication interface. The portable wireless device includes another wireless communication interface coupled to the wireless communication interface of the printer via a wireless link, an edit function module for providing an edit function to edit the electronic image, and a print function module capable of sending a printing request to the printer for printing the image. A printing method executable by the printing system is also disclosed.

### BACKGROUND

1. Technical Field

The present disclose relates to a printing system and method for printing an electronic image displayed by a portable wireless device.

2. Description of Related Art

Portable electronic devices such as personal digital assistant (PDA) devices and portable wireless handsets, e.g., cell phones, enjoy widespread popularity. In particular, the portable, hand-held characteristics of these devices provide users with access to information and communication outlets in ways that were never before available. To ensure the continued popularity of portable electronic devices, attempts are being made to further expand the flexibility and capabilities of these portable electronic devices and to further enhance the services available to the users. For example, some portable electronic devices have the capability to search for and display maps on their screens.

Sometimes, a user may want to print the map displayed on a screen of the portable electronic device. A typical printing method includes the following steps (See FIG. 3). The desired map is displayed on the screen of the portable electronic device. The map is captured and stored in a memory card of the portable electronic device. The memory card is taken out from the portable electronic device. Then the memory card is plugged to the printer for printing the desired map. The typical printing method is inconvenient to users.

Therefore, a printing system and method for more conveniently printing a map displayed by a portable electronic device is desired.

### BRIEF DESCRIPTION OF THE DRAWINGS

FIG. 1 illustrates a block diagram of a printing system in accordance with the present disclosure;

FIG. 2 illustrates a flow chart of a printing method in accordance with the present disclosure; and

FIG. 3 illustrates a flow chart of a typical printing method for printing a map displayed by a portable electronic device.

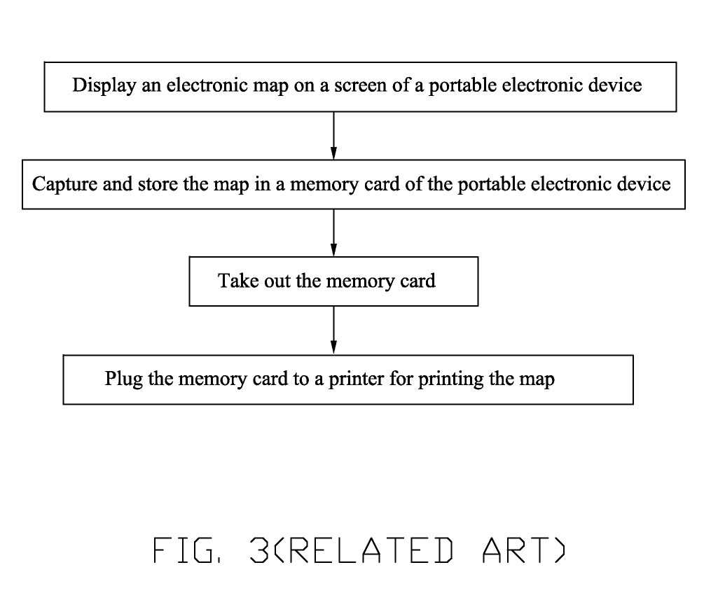

### DETAILED DESCRIPTION OF THE EMBODIMENTS

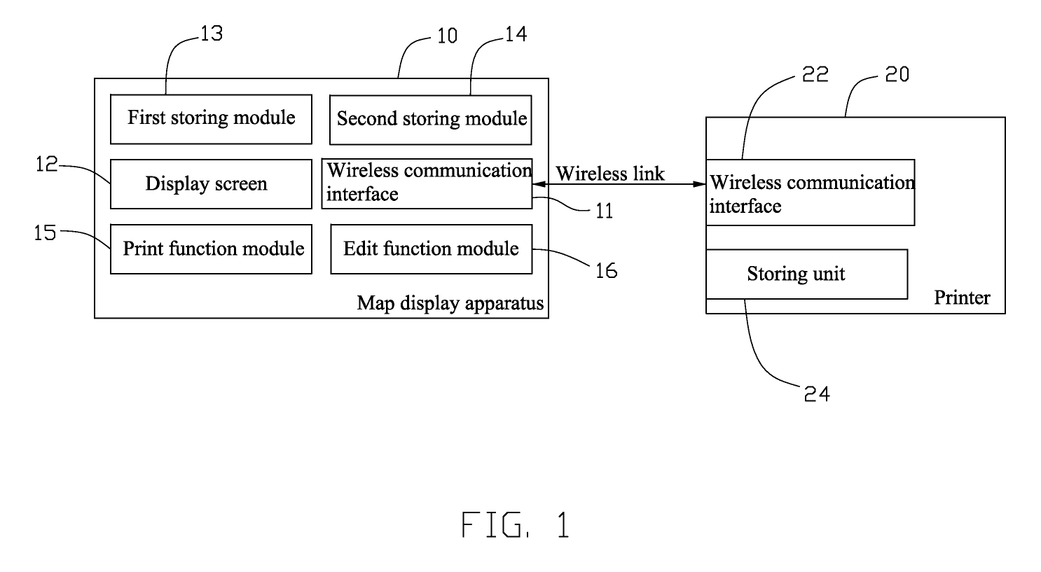

Referring to FIG. 1, an embodiment of a printing system includes a wireless map display apparatus 10 and a printer 20. The map display apparatus 10 is coupled to the printer 20 via a wireless link, such as a wireless fidelity (WIFI) link, or a BLUETOOTH link, etc. The map display apparatus 10 is a portable wireless device, such as a PDA device, or a smart cell phone, etc. While a map is used as an example, it is to be understood that files of various types can be printed.

The map display apparatus 10 includes a first wireless communication interface 11, a display screen 12 for displaying a map thereon, a first storing module 13 for storing data of multiple maps therein, a second storing module 14 for storing the map displayed on the display screen 12, a print function module 15, and an edit function module 16. The print function module 15 is capable of responding to an input print request from a user and sending a print command to the printer 20 for printing the map. The edit function module 16 provides an edit function to edit the map displayed on the display screen 12, allowing for example the addition of place names, road names, and street names on the map.

In an embodiment, a toolbar including a print button (a print shortcut key) and an edit button (an edit shortcut key) is displayed on the display screen 12 together with the map. After the print button is clicked, the print function module 15 receives a print request, and a print preview interface appears on the display screen 12. There is a print option, an edit option, and a cancel option in the print preview interface. If the print option is enabled, the print information is sent from the map display apparatus 10 to the printer 20 for printing. If the edit option is selected, the edit function module 16 is enabled, and the user can edit the map as described above.

The printer 20 includes a second wireless communication interface 22, coupled to the first wireless communication interface 11 of the map display apparatus 10, and a storing unit 24 for storing received print information. The printer 20 prints the map in response to receipt of the print information from the map display apparatus 10.

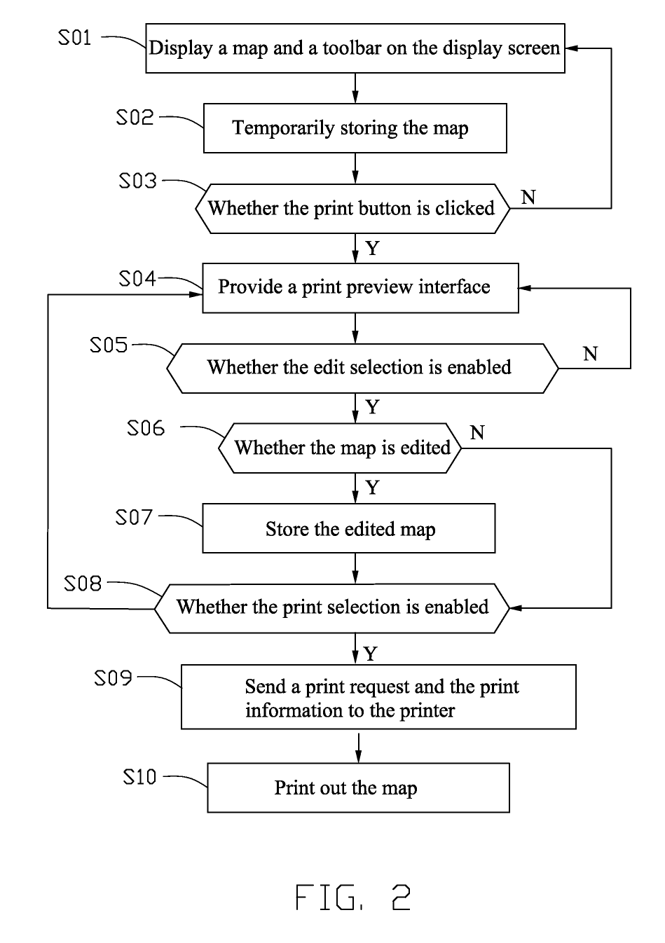

Referring to FIG. 2, a method executable by the printing system described above includes the following blocks.

In block S01, a map and a toolbar is displayed on the display screen 12 of the map display apparatus 10, the toolbar includes the print button and the edit button. In block S02, the second storing module 15 temporarily storing the map displayed on the display screen 12. In block S03, if the print button is clicked, go to block S04; if not, go back to block S01. In block S04, a print preview interface is provided by the display screen 12, the print preview interface includes the print option, the edit option, and the cancel option. In block S05, if the edit option is selected to enable the edit function module 16 of the map display apparatus 10, go to block S06; if not, go back to block S04. In block S06, if the map is edited, such as place names, road names, and street names being added, go to block S07; if the map is not edited, go to block S08. In block S07, the edited map is stored in the second storing module 15 and replaces the original one. In block S08, if the print option is selected to confirm the print instruction, go to block S09; if not, go back to S04. In block S09, the print function module 15 of the map display apparatus 10 sends a print request and the print information to the printer 20. In block S10, the map is printed according to the print information by the printer 20; if the map is not edited, the original map displayed on the screen is printed; and if the map is edited, the edited map is printed.

While the present disclosure has illustrated by the description preferred embodiments, and while the preferred embodiments have been described in considerable detail, it is not intended to restrict or in any way limit the scope of the appended claims to such details. Additional advantages and modifications within the spirit and scope of the present disclosure will readily appear to those skilled in the art. Therefore, the present disclosure is not limited to the specific details and illustrative examples shown and described.

It is also to be understood that the above description and the claims drawn to a method may include some indication in reference to certain steps. However, the indication used is only to be viewed for identification purposes and not as a suggestion as to an order for the steps.

1. A printing system comprising:
a portable wireless device capable of displaying an electronic image on a screen thereof, the portable wireless device capable of communicatively connecting to a printer via a wireless link, the portable wireless device comprising an edit function module capable of allowing editing the electronic image, and a print function module capable of sending a printing request to the printer to print the electronic image.

2. The printing system of claim 1, wherein the wireless link is a wireless fidelity link.

3. The printing system of claim 1, wherein the wireless link is a Bluetoothlink.

4. The printing system of claim 1, wherein the portable wireless device further comprises a first storing module for storing data of multiple electronic images, and a second storing module for temporarily storing the electronic image showed on the screen.

5. The printing system of claim 4, wherein the electronic image is a map, and the edit module is capable of providing an edit function to add specified place names, road names, and street names on the electronic map displayed on the screen.

6. The printing system of claim 5, wherein the second storing module is capable of storing the map added with the specified places names, road names, and street names to replace the electronic map originally stored in the second storing module.

7. The printing system of claim 1, wherein the portable wireless device is a personal digital assistant device.

8. The printing system of claim 1, wherein the portable wireless device is a cell phone.

9. The printing system of claim 1, wherein the screen is capable of displaying a toolbar together with the electronic image thereon, the toolbar comprises a print button and an edit button.

10. A method comprising:
connecting to a printer via a wireless link;
temporarily storing an electronic image showed on a screen of a portable wireless device;
determining whether the electronic image is edited;
if the electronic image is not edited, sending the electronic image to the printer for printing; and
if the electronic image is edited, storing the edited electronic image to replace the originally stored electronic image and sending the edited electronic image to the printer for printing.

11. The method of claim 10, wherein the screen of the portable wireless device displays a printing button for printing the electronic image and an edit button for editing the electronic image.

12. The method of claim 11, wherein a print preview interface appears after the printing button is clicked, the print preview interface comprises a print option to send a print request to the printer to print the electronic image, an edit option to edit the electronic image, and a cancel option to abandon the print request.

13. The method of claim 12, wherein after the edit button is clicked or the edit option is enabled, the electronic image displayed on the screen can be edited and added with specified place names, road names, and street names thereto.

14. The method of claim 10, wherein the wireless link conforms to a wireless fidelity standard.

15. The method of claim 10, wherein the wireless link conforms to a blue tooth standard.
